(19) United States
(12) Patent Application Publication
(10) Pub. No.: US 2006/0063410 A1
(43) Pub. Date: Mar. 23, 2006

(54) Connector for establishing an electrical connection between a wire and a fluorescent tube of a backlight module

(75) Inventor: Tang-Pung Lin, Tainan City (TW)

Correspondence Address: LINIAK, BERENATO & WHITE, Suite 240, 6550 Rock Spring Drive, Bethesda, MD, 20817-1132, US

(73) Assignee: CHI LIN TECHNOLOGY CO., LTD.

(21) Appl. No.: 10/943,883

(22) Filed: Sep. 20, 2004

(51) Int. Cl. H01R 33/08

(52) U.S. Cl. 439/242

(57) ABSTRACT

A connector, which serves to establish an electrical connection between a wire and a fluorescent tube of a backlight module, includes first and second clamping parts. The backlight module includes a support seat that supports the fluorescent tube and that is formed with a channel. The wire has an exposed conductor at an end portion thereof that extends into the channel. The fluorescent tube has an end portion that extends into the channel, and a pin that extends outwardly from the end portion of the fluorescent tube. The connector is disposed in the channel. The first clamping part clamps the exposed conductor of the wire. The second clamping part extends from the first clamping part and clamps the pin of the fluorescent tube.

### BACKGROUND OF THE INVENTION

1. Field of the Invention

The invention relates to a connector, more particularly to a connector that establishes an electrical connection between a wire and a fluorescent tube of a backlight module.

2. Description of the Related Art

A backlight module includes a support seat, a wire, and a fluorescent tube. The support seat serves to support the fluorescent tube, and is formed with a channel. The wire includes insulated stranded conductors. The wire has an end portion that is stripped to expose the conductors, and that extends into the channel. The fluorescent tube has an end portion that extends into the channel, and a pin that extends outwardly from the end portion of the fluorescent tube.

Referring to FIG. 1, a conventional method for establishing an electrical connection between a wire 11 and a fluorescent tube 13 includes the steps of:

(a) stripping the end portion of the wire 11 to expose the conductors 111;

(b) braiding the exposed conductors 111;

(c) forming the braided exposed conductors 111 into a loop; (after forming the loop, the exposed conductors 111 are coated with solder;

(d) passing the end portion of the wire 11 through the channel 120 in the support seat 12;

(e) soldering the exposed conductors 111 to the pin 131 of the fluorescent tube 13; and

(f) positioning the wire 11 such that the end portion of the fluorescent tube 13 extends into the channel 120.

Although the aforementioned conventional method may be performed to establish electrical connection between the wire 11 and the fluorescent tube 13, it involves time-consuming steps, which result in manufacturing inefficiency and an increase in labor costs. Moreover, fumes produced in step (c) and (e) pose a danger to the health of the worker.

### SUMMARY OF THE INVENTION

Therefore, the object of the present invention is to provide a solderless connector so as to overcome the aforesaid drawbacks of the prior art.

According to the present invention, a connector, which serves to establish an electrical connection between a wire and a fluorescent tube of a backlight module, includes first and second clamping parts. The backlight module includes a support seat that supports the fluorescent tube and that is formed with a channel. The wire has an exposed conductor at an end portion thereof that extends into the channel. The fluorescent tube has an end portion that extends into the channel, and a pin that extends outwardly from the end portion thereof. The connector is disposed in the channel. The first clamping part clamps the exposed conductor of the wire. The second clamping part extends from the first clamping part and clamps the pin of the fluorescent tube.

### BRIEF DESCRIPTION OF THE DRAWINGS

Other features and advantages of the present invention will become apparent in the following detailed description of the preferred embodiment with reference to the accompanying drawings, of which:

FIG. 1 illustrates a conventional method of establishing an electrical connection between a wire and a fluorescent tube of a backlight module;

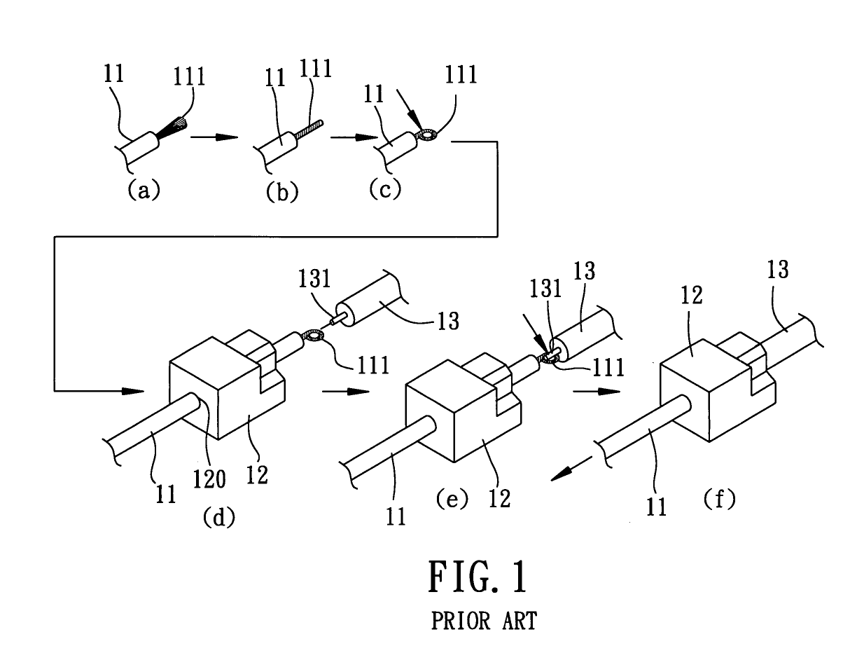

FIG. 2 is a perspective view of the preferred embodiment of a connector according to the present invention;

FIG. 3 is a partly sectional view to illustrate how a wire and a fluorescent tube are connected through the preferred embodiment;

FIG. 4 illustrates a method of establishing an electrical connection between a wire and a fluorescent tube of a backlight module using the preferred embodiment; and

FIG. 5 is a perspective view of a modified connector of the preferred embodiment.

### DETAILED DESCRIPTION OF THE PREFERRED EMBODIMENT

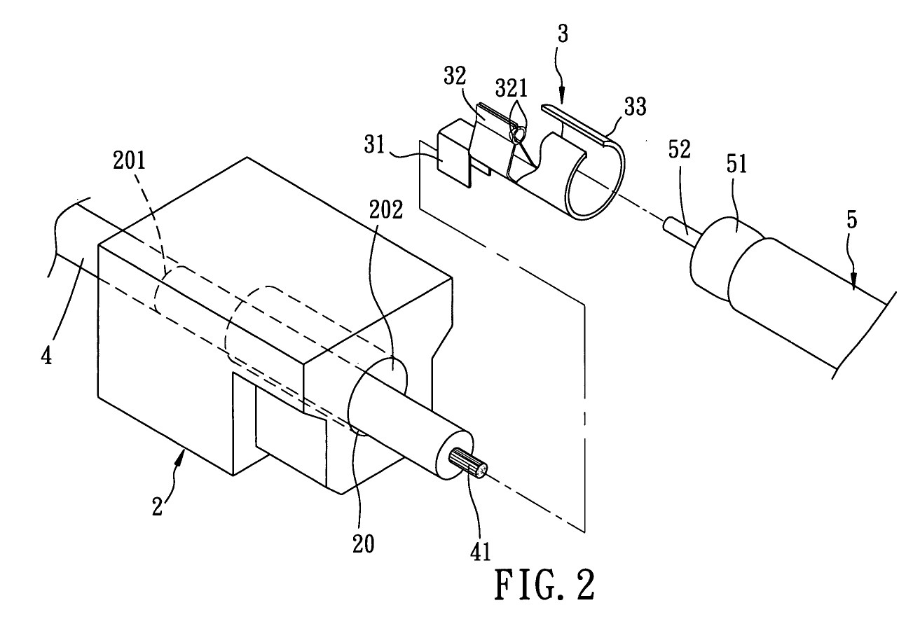

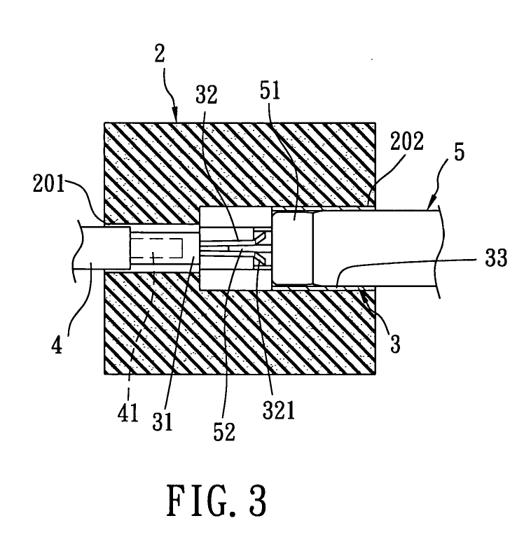

Referring to FIGS. 2 and 3, the preferred embodiment of a connector 3 according to this invention is shown to include first, second, and third clamping parts 31, 32, 33.

The connector 3 is made from a conductive material, such as gold, and serves to establish an electrical connection between a wire 4 and a fluorescent tube 5 of a backlight module (not shown). The backlight module includes a support seat 2 that supports the fluorescent tube 4, and that is formed with a channel 20. The channel 20 has first and second open ends 201, 202. It is noted that the support seat 2 is made from an elastic material, such as a rubber or a plastic. As shown in FIG. 3, the connector 3 is adapted to be disposed in the channel 20. The wire 4 includes insulated stranded conductors 41, and has an end portion that is stripped to expose the conductors 41. The fluorescent tube 5 has an end portion 51, and a pin 52 that extends outwardly from the end portion 51 of the fluorescent tube 5. As shown in FIG. 3, the end portion of the wire 4 extends into the channel 20 through the first open end 201, whereas the end portion 51 of the fluorescent tube 5 extends into the channel 20 through the second open end 202.

The first clamping part 31 is inverted U-shaped, and includes a pair of crimping arms, each of which extends in a first direction. The crimping arms of the first clamping part 31 are adapted to clamp securely the exposed conductors 41 of the wire 4.

The second clamping part 32 extends between the first and third clamping parts 31, 33, and includes a pair of clamping arms, each of which extends in a second direction opposite to the first direction, and that converge toward each other. The clamping arms of the second clamping part 32 are adapted to clamp releasably the pin 52 of the fluorescent tube 5 therebetween. The second clamping part 32 further includes a pair of guide flanges 321 formed respectively on the clamping arms of the second clamping part 32. The guide flanges 321 confine a converging entrance that serves to guide insertion of the pin 52 of the fluorescent tube 5 between the clamping arms of the second clamping part 32.

The third clamping part 33 is C-shaped, and is adapted to clamp the end portion 51 of the fluorescent tube 5.

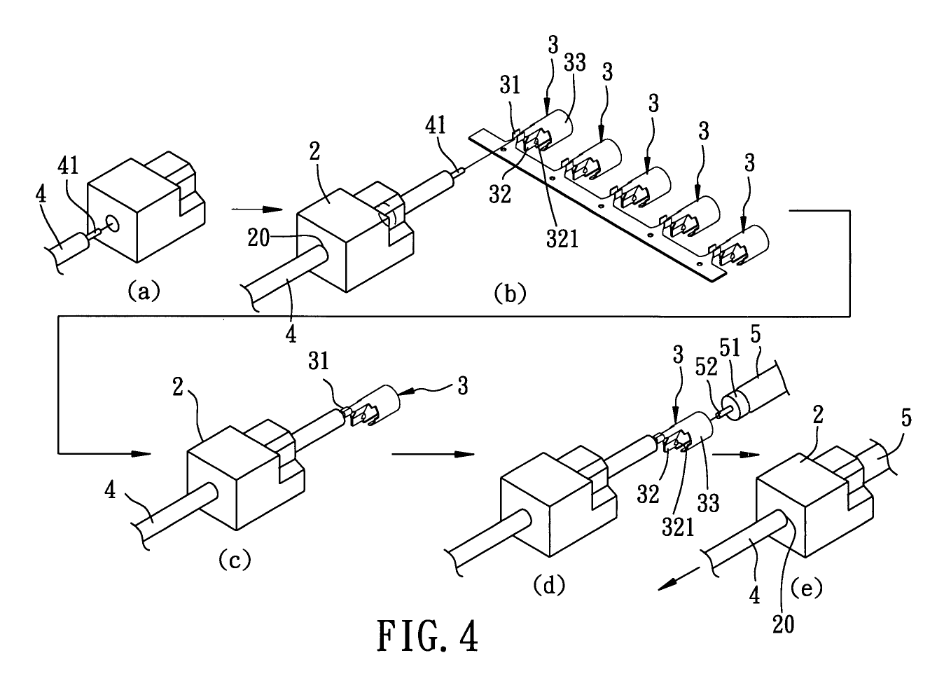

Referring to FIG. 4, a method for establishing an electrical connection between the wire 4 and the fluorescent tube 5 using the connector 3 of the preferred embodiment includes the steps of:

(a) stripping the end portion of the wire 4 to expose the conductors 41;

(b) passing the end portion of the wire 4 through the channel 20 in the support seat 2;

(c) connecting the wire 4 to the connector 3 by crimping the exposed conductors 41 of the wire 4 to the crimping arms of the first clamping part 31 of the connector 3 with the use of a crimping tool (not shown)

(d) bringing the fluorescent tube 5 toward the connector 3 and manipulating the fluorescent tube 5 such that the pin 52 of the fluorescent tube 5 is inserted between the clamping arms of the second clamping part 32 through the guide flanges 321 and such that the end portion 51 of the fluorescent tube 5 is press-fitted into the third clamping part 33; and

(e) pulling the wire 4 such that the connector 3 is disposed in and such that the end portion of the fluorescent tube 5 extends into the channel 20 of the support seat 2.

It is noted that a set of the connectors 3 can be constructed at one time by pressing or stamping a metal sheet (not shown) . It is also noted that, with the use of an automated crimping machine (not shown), a plurality of the wires 4 can be connected simultaneously to the set of the connectors 3. It is further noted that step (d) may be performed after step (e).

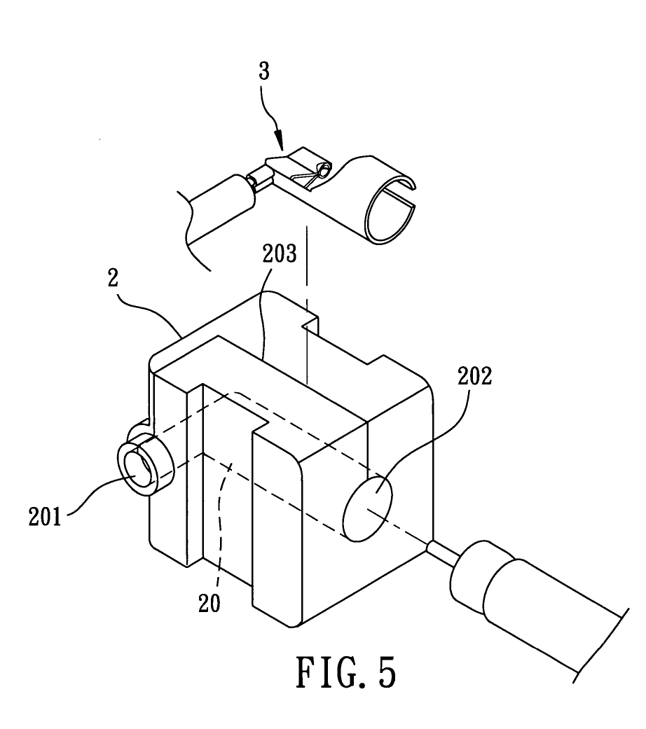

Referring to FIG. 5, the channel 20 in the support seat 2 is L-shaped. The support seat 2 is formed with a slit 203 for permitting the connector 3 to be disposed in the channel 20. In particular, after performing steps (a) and (c) of the aforementioned method, the crimping arms of the first clamping part 31 are bent, the slit 203 is stretched opened, and the connector 3 is disposed in the channel 20. Thereafter, step (d) of the aforementioned method is performed.

It has thus been shown that the connector 3 of this invention, which serves to establish an electrical connection between a wire and a fluorescent tube of a backlight module, includes first and second clamping parts 31, 32. The first clamping part 31 includes a pair of crimping arms for clamping securely exposed conductors at an end of the wire. The second clamping part 32 includes a pair of clamping arms for clamping releasably a pin of the fluorescent tube 5. Therefore, the electrical connection between the wire and the fluorescent tube can be established without soldering.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A connector for establishing an electrical connection between a wire and a fluorescent tube of a backlight module, the backlight module including a support seat that supports the fluorescent tube and that is formed with a channel, the wire having an exposed conductor at an end portion thereof extending into the channel, the fluorescent tube having an end portion that extends into the channel, and a pin that extends outwardly from the end portion of the fluorescent tube, said connector being adapted to be disposed in the channel, and comprising:
a first clamping part adapted to clamp the exposed conductor of the wire; and
a second clamping part including a pair of clamping arms that extend from said first clamping part, that cooperate to confine a pin-holding space adapted for receiving the pin of the fluorescent tube , and that are adapted to contact directly and simultaneously the pin so as to clamp the pin therebetween and so as to hold the pin in the pin-holding space.

2. (canceled)

3. The connector as claimed in claim 1, wherein said second clamping part further includes a pair of guide flanges formed respectively on said clamping arms of said second clamping part at one end of said pin-holding space, said guide flanges confining a converging entrance for guiding insertion of the pin of the fluorescent tube into said pin-holding space when the pin is to be clamped between said clamping arms of said second clamping part.

4. The connector as claimed in claim 1, wherein said first clamping part includes a pair of crimping arms adapted to clamp the exposed conductor of the wire.

5. The connector as claimed in claim 1, further comprising a third clamping part adapted to clamp the end portion of the fluorescent tube, said second clamping part extending between said first and third clamping parts.

6. The connector as claimed in claim 5, wherein said third clamping part is C-shaped.

7. A backlight module, comprising:
a support seat formed with a channel;
a wire having an exposed conductor at an end portion thereof that extends into said channel;
a fluorescent tube having an end portion that extends into said channel, and a pin that extends outwardly from said end portion of said fluorescent tube; and
a connector for establishing an electrical connection between said wire and said fluorescent tube, said connector being disposed in said channel, and including
a first clamping part that clamps said exposed conductor of said wire, and
a second clamping part that includes a pair of clamping arms extending from said first clamping part, cooperating to confine a pin-holding space for receiving said pin of said fluorescent tube, and contacting directly and simultaneously said pin so as to clamp said pin therebetween and so as to hold said pin in said pin-holding space.

8. The backlight module as claimed in claim 7, wherein said second clamping part further includes a pair of guide flanges formed respectively on said clamping arms of said second clamping part at one end of said pin-holding space, said guide flanges confining a converging entrance for guiding insertion of said pin of said fluorescent tube into said pin-holding space when said pin is to be clamped between said clamping arms of said second clamping part.

9. The backlight module as claimed in claim 7, wherein said first clamping part includes a pair of crimping arms that clamp said exposed conductor of said wire.

10. The backlight module as claimed in claim 7, wherein said connector further includes a third clamping part for clamping said end portion of said fluorescent tube, said second clamping part extending between said first and third clamping parts.

11. The backlight module as claimed in claim 10, wherein said third clamping part is C-shaped.
